(19) United States
(12) Patent Application Publication
(10) Pub. No.: US 2011/0043540 A1
(43) Pub. Date: Feb. 24, 2011

(54) SYSTEM AND METHOD FOR REGION CLASSIFICATION OF 2D IMAGES FOR 2D-TO-3D CONVERSION

(76) Inventors: James Arthur Fancher, Los Angeles, CA (US); Dong-Qing Zhang, Burbank, CA (US); Ana Belen Benitez, Brooklyn, CA (US)

Correspondence Address: Robert D. Shedd, Patent Operations;THOMSON Licensing LLC, P.O. Box 5312, Princeton, NJ, 08543-5312, US

(21) Appl. No.: 12/531,906

(22) PCT Filed: Mar. 23, 2007
(86) PCT No.: PCT/US07/07234

§ 371 Date: Sep. 18, 2009

(51) Int. Cl. G09G 5/00

(52) U.S. Cl. 345/672

(57) ABSTRACT

A system and method for region classification of two-dimensional images for 2D-to-3D conversion of images to create stereoscopic images are provided. The system and method of the present disclosure provides for acquiring a two-dimensional image, identifying a region of the 2D image, extracting features from the region, classifying the extracted features of the region, selecting a conversion mode based on the classification of the identified region, converting the region into a 3D model based on the selected conversion mode, and creating a complementary image by projecting the 3D model onto an image plane different than an image plane of the 2D image. A learning component optimizes the classification parameters to achieve minimum classification error of the region using a set of training images and corresponding user annotations.

### TECHNICAL FIELD OF THE INVENTION

The present disclosure generally relates to computer graphics processing and display systems, and more particularly, to a system and method for region classification of two-dimensional (2D) images for 2D-to-3D conversion.

### BACKGROUND OF THE INVENTION

2D-to-3D conversion is a process to convert existing two-dimensional (2D) films into three-dimensional (3D) stereoscopic films. 3D stereoscopic films reproduce moving images in such a way that depth is perceived and experienced by a viewer, for example, while viewing such a film with passive or active 3D glasses. There have been significant interests from major film studios in converting legacy films into 3D stereoscopic films.

Stereoscopic imaging is the process of visually combining at least two images of a scene, taken from slightly different viewpoints, to produce the illusion of three-dimensional depth. This technique relies on the fact that human eyes are spaced some distance apart and do not, therefore, view exactly the same scene. By providing each eye with an image from a different perspective, the viewer's eyes are tricked into perceiving depth. Typically, where two distinct perspectives are provided, the component images are referred to as the “left” and “right” images, also know as a reference image and complementary image, respectively. However, those skilled in the art will recognize that more than two viewpoints may be combined to form a stereoscopic image.

Stereoscopic images may be produced by a computer using a variety of techniques. For example, the “anaglyph” method uses color to encode the left and right components of a stereoscopic image. Thereafter, a viewer wears a special pair of glasses that filters light such that each eye perceives only one of the views.

Similarly, page-flipped stereoscopic imaging is a technique for rapidly switching a display between the right and left views of an image. Again, the viewer wears a special pair of eyeglasses that contains high-speed electronic shutters, typically made with liquid crystal material, which open and close in sync with the images on the display. As in the case of anaglyphs, each eye perceives only one of the component images.

Other stereoscopic imaging techniques have been recently developed that do not require special eyeglasses or headgear. For example, lenticular imaging partitions two or more disparate image views into thin slices and interleaves the slices to form a single image. The interleaved image is then positioned behind a lenticular lens that reconstructs the disparate views such that each eye perceives a different view. Some lenticular displays are implemented by a lenticular lens positioned over a conventional LCD display, as commonly found on computer laptops.

Another stereoscopic imaging technique involves shifting regions of an input image to create a complementary image. Such techniques have been utilized in a manual 2D-to-3D film conversion system developed by a company called In-Three, Inc. of Westlake Village, Calif. The 2D-to-3D conversion system is described in U.S. Pat. No. 6,208,348 issued on Mar. 27, 2001 to Kaye. Although referred to as a 3D system, the process is actually 2D because it does not convert a 2D image back into a 3D scene, but rather manipulates the 2D input image to create the right-eye image. FIG. 1 illustrates the workflow developed by the process disclosed in U.S. Pat. No. 6,208,348, where FIG. 1 originally appeared as FIG. 5 in U.S. Pat. No. 6,208,348. The process can be described as the following: for an input image, regions 2, 4, 6 are first outlined manually. An operator then shifts each region to create stereo disparity, e.g., 8, 10, 12. The depth of each region can be seen by viewing its 3D playback in another display by 3D glasses. The operator adjusts the shifting distance of the region until an optimal depth is achieved. However, the 2D-to-3D conversion is achieved mostly manually by shifting the regions in the input 2D images to create the complementary right-eye images. The process is very inefficient and requires enormous human intervention.

Recently, automatic 2D-to-3D conversion systems and methods have been proposed. However, certain methods have better results than others depending on the type of object being converted in the image, e.g., fuzzy objects, solid objects, etc. Since most images contain both fuzzy objects and solid objects, an operator of the system would need to manually select the objects in the images and then manually select the corresponding 2D-to-3D conversion mode for each object. Therefore, a need exists for techniques for automatically selecting the best 2D-to-3D conversion mode among a list of candidates to achieve the best results based on the local image content.

### SUMMARY

A system and method for region classification of two-dimensional (2D) images for 2D-to-3D conversion of images to create stereoscopic images are provided. The system and method of the present disclosure utilizes a plurality of conversion methods or modes (e.g., converters) and selects the best approach based on content in the images. The conversion process is conducted on a region-by-region basis where regions in the images are classified to determine the best converter or conversion mode available. The system and method of the present disclosure uses a pattern-recognition-based system that includes two components: a classification component and a learning component. The inputs to the classification component are features extracted from a region of a 2D image and the output is an identifier of the 2D-to-3D conversion modes or converters expected to provide the best results. The learning component optimizes the classification parameters to achieve minimum classification error of the region using a set of training images and corresponding user annotations. For the training images, the user annotates the identifier of the best conversion mode or converter to each region. The learning component then optimizes the classification (i.e., learns) by using the visual features of the regions for training and their annotated converter identifiers. After each region of an image is converted, a second image (e.g., the right eye image or complementary image) is created by projecting the 3D scene, which includes the converted 3D regions or objects, onto another imaging plane with a different camera view angle.

According to one aspect of the present disclosure, a three-dimensional (3D) conversion method for creating stereoscopic images includes acquiring a two-dimensional image; identifying a region of the two dimensional image; classifying the identified region; selecting a conversion mode based on the classification of the identified region; converting the region into a three-dimensional model based on the selected conversion mode; and creating a complementary image by projecting the three-dimensional model onto an image plane different than an image plane of the two-dimensional image.

In another aspect, the method includes extracting features from the region; classifying the extracted features and selecting the conversion mode based on the classification of the extracted features. The extracting step further includes determining a feature vector from the extracted features, wherein the feature vector is employed in the classifying step to classify the identified region. The extracted features may include texture and edge direction features.

In a further aspect of the present disclosure, the conversion mode is a fuzzy object conversion mode or a solid object conversion mode.

In yet a further aspect of the present disclosure, the classifying step further includes acquiring a plurality of 2D images; selecting a region in each of the plurality of 2D images; annotating the selected region with an optimal conversion mode based on a type of the selected region; and optimizing the classifying step based on the annotated 2D images, wherein the type of the selected region corresponds to a fuzzy object or solid object.

According to another aspect of the present disclosure, a system for three-dimensional (3D) conversion of objects from two-dimensional (2D) images is provided.

The system includes a post-processing device configured for creating a complementary image from at least one 2D image; the post-processing device including a region detector configured for detecting at least one region in at least one 2D image; a region classifier configured for classifying a detected region to determine an identifier of at least one converter; the at least one converter configured for converting a detected region into a 3D model; and a reconstruction module configured for creating a complementary image by projecting the selected 3D model onto an image plane different than an image plane of the at least one 2D image. The at least one converter may include a fuzzy object converter or a solid object converter.

In another aspect, the system further includes a feature extractor configured to extract features from the detected region. The extracted features may include texture and edge direction features.

According to yet another aspect, the system further includes a classifier learner configured to acquire a plurality of 2D images, select at least one region in each of the plurality of 2D images and annotate the selected at least one region with the identifier of an optimal converter based on a type of the selected at least one region, wherein the region classifier is optimized based on the annotated 2D images.

In a further aspect of the present disclosure, a program storage device readable by a machine, tangibly embodying a program of instructions executable by the machine to perform method steps for creating stereoscopic images from a two-dimensional (2D) image is provided, the method including acquiring a two-dimensional image; identifying a region of the two-dimensional image; classifying the identified region; selecting a conversion mode based on the classification of the identified region; converting the region into a three-dimensional model based on the selected conversion mode; and creating a complementary image by projecting the three-dimensional model onto an image plane different than an image plane of the two-dimensional image.

### BRIEF DESCRIPTION OF THE DRAWINGS

These, and other aspects, features and advantages of the present disclosure will be described or become apparent from the following detailed description of the preferred embodiments, which is to be read in connection with the accompanying drawings.

In the drawings, wherein like reference numerals denote similar elements throughout the views:

FIG. 1 illustrates a prior art technique for creating a right-eye or complementary image from an input image;

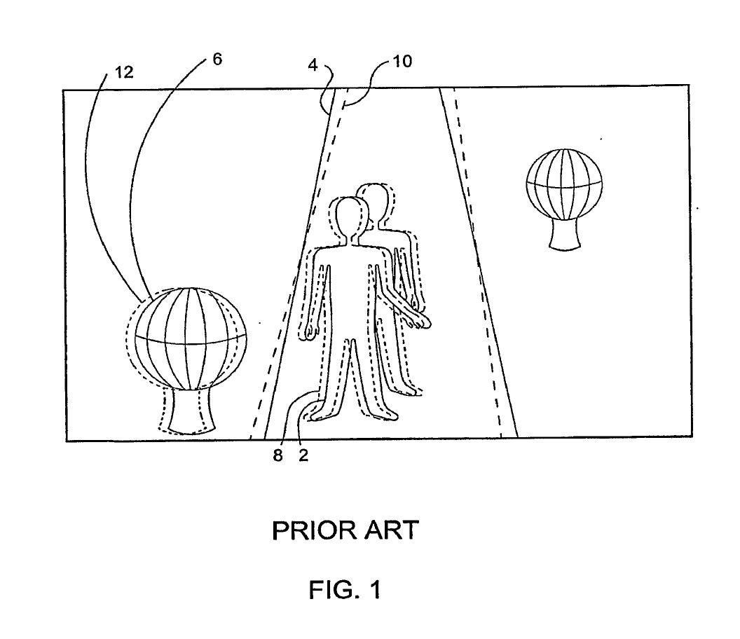

FIG. 2 is a flow diagram illustrating a system and method for region classification of two-dimensional (2D) images for 2D-to-3D conversion of the images according to an aspect of the present disclosure;

FIG. 3 is an exemplary illustration of a system for two-dimensional (2D) to three-dimensional (3D) conversion of images for creating stereoscopic images according to an aspect of the present disclosure; and

FIG. 4 is a flow diagram of an exemplary method for converting two-dimensional (2D) images to three-dimensional (3D) images for creating stereoscopic images according to an aspect of the present disclosure.

It should be understood that the drawing(s) is for purposes of illustrating the concepts of the disclosure and is not necessarily the only possible configuration for illustrating the disclosure.

### DETAILED DESCRIPTION OF PREFERRED EMBODIMENTS

It should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces.

The present description illustrates the principles of the present disclosure. It will thus be appreciated that those skilled in the art will be able to devise various arrangements that, although not explicitly described or shown herein, embody the principles of the disclosure and are included within its spirit and scope.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

The present disclosure deals with the problem of creating 3D geometry from 2D images. The problem arises in various film production applications, including visual effects (VXF), 2D film to 3D film conversion, among others. Previous systems for 2D-to-3D conversion are realized by creating a complimentary image (also known as a right-eye image) by shifting selected regions in the input image, therefore, creating stereo disparity for 3D playback. The process is very inefficient, and it is difficult to convert regions of images to 3D surfaces if the surfaces are curved rather than flat.

There are different 2D-to-3D conversion approaches that work better or worse based on the content or the objects depicted in a region of the 2D image. For example, 3D particle systems work better for fuzzy objects; whereas, 3D geometry model fitting does a better job for solid objects. These two approaches actually complement each other since it is in general difficult to estimate accurate geometry for fuzzy objects, and vice versa. However, most 2D images in movies contain fuzzy objects such as trees and solid objects such as buildings that are best represented by particle systems and 3D geometry models, respectively. So, assuming there are several available 2D-to-3D conversion modes, the problem is to select the best approach according to the region content. Therefore, for general 2D-to-3D conversion, the present disclosure provides techniques to combine these two approaches, among others, to achieve the best results. The present disclosure provides a system and method for general 2D-to-3D conversion that automatically switches between several available conversion approaches according to the local content of the images. The 2D-to-3D conversion is, therefore, fully automated.

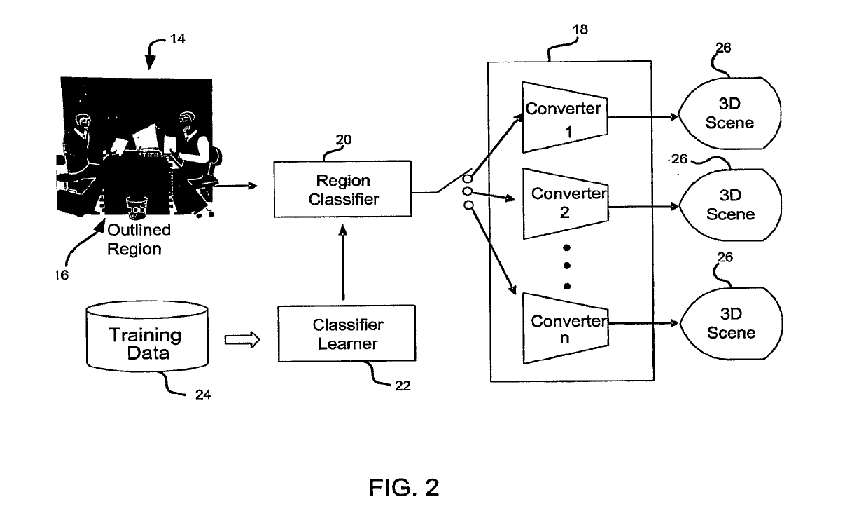

A system and method for region classification of two-dimensional (2D) images for 2D-to-3D conversion of images to create stereoscopic images are provided. The system and method of the present disclosure provide a 3D-based technique for 2D-to-3D conversion of images to create stereoscopic images. The stereoscopic images can then be employed in further processes to create 3D stereoscopic films. Referring to FIG. 2, the system and method of the present disclosure utilizes a plurality of conversion methods or modes (e.g., converters) 18 and selects the best approach based on content in the images 14. The conversion process is conducted on a region-by-region basis where regions 16 in the images 14 are classified to determine the best converter or conversion mode 18 available. The system and method of the present disclosure uses a pattern-recognition-based system that includes two components: a classification component 20 and a learning component 22. The inputs to the classification component 20, or region classifier, are features extracted from a region 16 of a 2D image 14 and the output of the classification component 20 is an identifier (i.e., an integer number) of the 2D-to-3D conversion modes or converters 18 expected to provide the best results. The learning component 22, or classifier learner, optimizes the classification parameters of the region classifier 20 to achieve minimum classification error of the region using a set of training images 24 and corresponding user annotations. For the training images 24, the user annotates the identifier of the best conversion mode or converter 18 to each region 16. The learning component then optimizes the classification (i.e., learns) by using the converter index and visual features of the region. After each region of an image is converted, a second image (e.g., the right eye image or complementary image) is created by projecting the 3D scene 26, which includes the converted 3D regions or objects, onto another imaging plane with a different camera view angle.

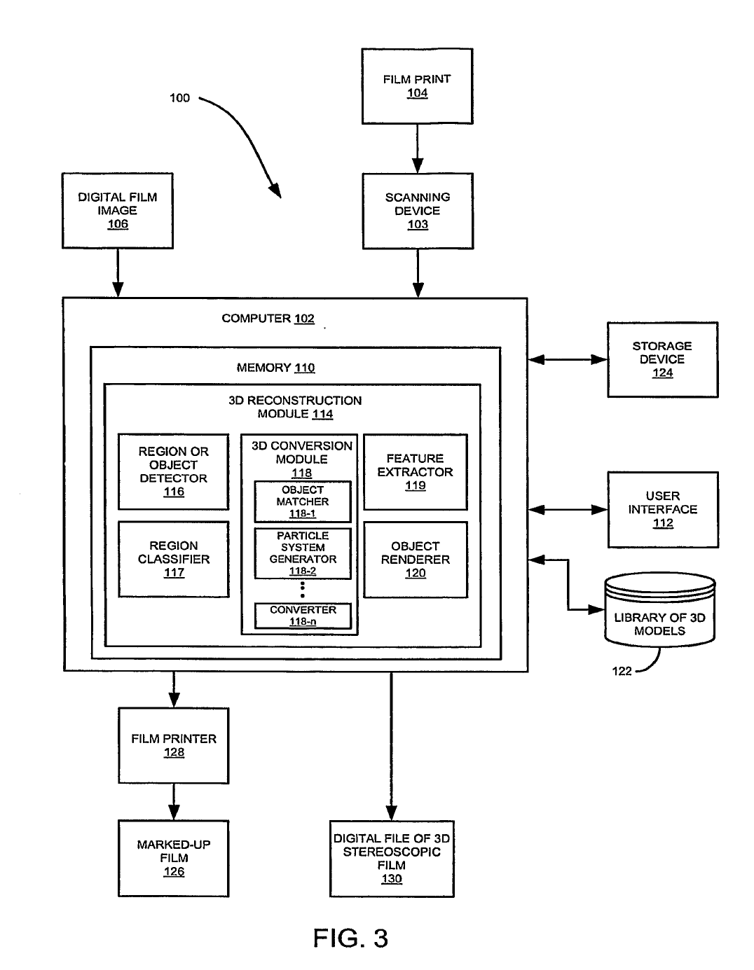

Referring now to FIG. 3, exemplary system components according to an embodiment of the present disclosure are shown. A scanning device 103 may be provided for scanning film prints 104, e.g., camera-original film negatives, into a digital format, e.g., a Cineon-format or SMPTE DPX files. The scanning device 103 may comprise, e.g., a telecine or any device that will generate a video output from film such as, e.g., an Arri LocPro™ with video output. Alternatively, files from the post production process or digital cinema 106 (e.g., files already in computer-readable form) can be used directly. Potential sources of computer-readable files are AVID™ editors, DPX files, D5 tapes etc.

Scanned film prints are input to a post-processing device 102, e.g., a computer. The computer is implemented on any of the various known computer platforms having hardware such as one or more central processing units (CPU), memory 110 such as random access memory (RAM) and/or read only memory (ROM) and input/output (I/O) user interface(s) 112 such as a keyboard, cursor control device (e.g., a mouse or joystick) and display device. The computer platform also includes an operating system and micro instruction code. The various processes and functions described herein may either be part of the micro instruction code or part of a software application program (or a combination thereof) which is executed via the operating system. In addition, various other peripheral devices may be connected to the computer platform by various interfaces and bus structures, such a parallel port, serial port or universal serial bus (USB). Other peripheral devices may include additional storage devices 124 and a printer 128. The printer 128 may be employed for printing a revised version of the film 126, e.g., a stereoscopic version of the film, wherein a scene or a plurality of scenes may have been altered or replaced using 3D modeled objects as a result of the techniques described below.

Alternatively, files/film prints already in computer-readable form 106 (e.g., digital cinema, which for example, may be stored on external hard drive 124) may be directly input into the computer 102. Note that the term “film” used herein may refer to either film prints or digital cinema.

A software program includes a three-dimensional (3D) reconstruction module 114 stored in the memory 110 for converting two-dimensional (2D) images to three-dimensional (3D) images for creating stereoscopic images. The 3D conversion module 114 includes a region or object detector 116 for identifying objects or regions in 2D images. The region or object detector 116 identifies objects either manually by outlining image regions containing objects by image editing software or by isolating image regions containing objects with automatic detection algorithms, e.g., segmentation algorithms. A feature extractor 119 is provided to extract features from the regions of the 2D images. Feature extractors are known in the art and extract features including but not limited to texture, line direction, edges, etc.

The 3D reconstruction module 114 also includes a region classifier 117 configured to classify the regions of the 2D image and determine the best available converter for a particular region of an image. The region classifier 117 will output an identifier, e.g., an integer number, for identifying the conversion mode or converter to be used for the detected region. Furthermore, the 3D reconstruction module 114 includes a 3D conversion module 118 for converting the detected region into a 3D model. The 3D conversion module 118 includes a plurality of converters 118-1 . . . 118-n, where each converter is configured to convert a different type of region. For example, solid objects or regions containing solid objects will be converted by object matcher 118-1, while fuzzy regions or objects will be converted by particle system generator 118-2. An exemplary converter for solid objects is disclosed in commonly owned PCT Patent Application PCT/US2006/044834, filed on Nov. 17, 2006, entitled “SYSTEM AND METHOD FOR MODEL FITTING AND REGISTRATION OF OBJECTS FOR 2D-TO-3D CONVERSION” (hereinafter “the '834 application”) and an exemplary converter for fuzzy objects is disclosed in commonly owned PCT Patent Application PCT/US2006/042586, filed on Oct. 27, 2006, entitled “SYSTEM AND METHOD FOR RECOVERING THREE-DIMENSIONAL PARTICLE SYSTEMS FROM TWO-DIMENSIONAL IMAGES” (hereinafter “the '586 application”), the contents of which are hereby incorporated by reference in their entireties.

It is to be appreciated that the system includes a library of 3D models that will be employed by the various converters 118-1 . . . 118-n. The converters 118 will interact with various libraries of 3D models 122 selected for the particular converter or conversion mode. For example, for the object matcher 118-1, the library of 3D models 122 will include a plurality of 3D object models where each object model relates to a predefined object. For the particle system generator 118-2, the library 122 will include a library of predefined particle systems.

An object renderer 120 is provided for rendering the 3D models into a 3D scene to create a complementary image. This is realized by a rasterization process or more advanced techniques, such as ray tracing or photon mapping.

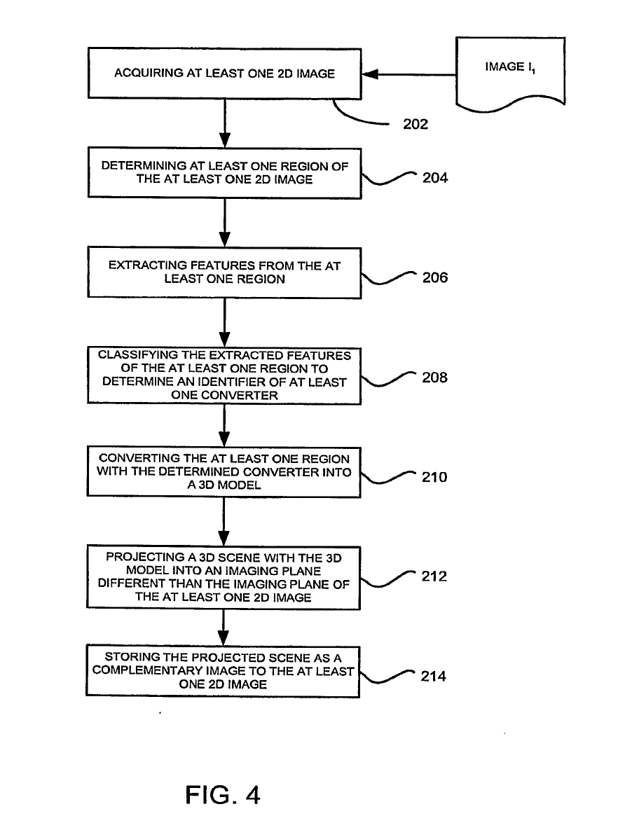

FIG. 4 is a flow diagram of an exemplary method for converting two-dimensional (2D) images to three-dimensional (3D) images for creating stereoscopic images according to an aspect of the present disclosure. Initially, at step 202, the post-processing device 102 acquires at least one two-dimensional (2D) image, e.g., a reference or left-eye image. The post-processing device 102 acquires at least one 2D image by obtaining the digital master video file in a computer-readable format, as described above. The digital video file may be acquired by capturing a temporal sequence of video images with a digital video camera. Alternatively, the video sequence may be captured by a conventional film-type camera. In this scenario, the film is scanned via scanning device 103. The camera will acquire 2D images while moving either the object in a scene or the camera. The camera will acquire multiple viewpoints of the scene.

It is to be appreciated that whether the film is scanned or already in digital format, the digital file of the film will include indications or information on locations of the frames, e.g., a frame number, time from start of the film, etc. Each frame of the digital video file will include one image, e.g., I₁, I₂, . . . , Iₙ.

In step 204, a region in the 2D image is identified or detected. It is to be appreciated that a region can contain several objects or can be part of an object. Using the region detector 116, an object or region may be manually selected and outlined by a user using image editing tools, or alternatively, the object or region may be automatically detected and outlined using image detection algorithms, e.g., object detection or region segmentation algorithms. It is to be appreciated that a plurality of objects or regions may be identified in the 2D image.

Once the region is identified or detected, features are extracted, at step 206, from the detected region via feature extractor 119 and the extracted features are classified, at step 208, by the region classifier 117 to determine an identifier of at least one of the plurality of converters 118 or conversion modes. The region classifier 117 is basically a function that outputs the identifier of the best expected converter according to features extracted from regions. In various embodiments, different features can be chosen. For a particular classification purpose (i.e. select solid object converter 118-1 or particle system converter 118-2), texture features may perform better than other features such as color since particle systems usually have richer textures than the solid objects. Furthermore, many solid objects, such as buildings, have prominent vertical and horizontal lines, therefore, edge direction may be the most relevant feature. Below is one example of how texture feature and edge feature can be used as inputs to the region classifier 117.

Texture features can be computed in many ways. Gabor wavelet feature is one of the most widely used texture features in image processing. The extraction process first applies a set of Gabor kernels with different spatial frequencies to the image and then computes the total pixel intensity of the filtered image. The filter kernel function follows:

$$h ( x , y ) = \frac{1}{2 {πσ}_{g}^{2}} exp [ - \frac{{x}^{2} + {y}^{2}}{2 {πσ}_{g}^{2}} ] exp ( j2π F ( x cos θ + y sin θ ) ) \qquad ( 1 )$$

where F is the spatial frequency and θ is the direction of the Gabor filter. Assuming for illustration purposes 3 levels of spatial frequencies and 4 directions (e.g., only cover angles from 0−π due to symmetry), then, the number of Gabor filter features is 12.

Edge features can be extracted by first applying horizontal and vertical line detection algorithms to the 2D image and, then, counting the edge pixels. Line detection can be realized by applying directional edge filters and, then, connecting the small edge segments into lines. Canny edge detection can be used for this purpose and is known in the art. If only horizontal lines and vertical lines (e.g., for the case of buildings) are to be detected, then, a two-dimensional feature vector, a dimension for each direction, is obtained. The two-dimensional case described is for illustration purposes only and can be easily extended to more dimensions.

If texture features have N dimensions, and edge directional features have M dimensions, then all of these features can be put together in a large feature vector with (N+M) dimensions. For each region, the extracted feature vector is input to the region classifier 117. The output of the classifier is the identifier of the recommended 2D-to-3D converter 118. It is to be appreciated that the feature vector could be different depending on different feature extractors. Furthermore, the input to the region classifier 117 can be other features than those described above and can be any feature that is relevant to the content in the region.

For learning the region classifier 117, training data which contains images with different kinds of regions is collected. Each region in the images is then outlined and manually annotated with the identifier of the converter or conversion mode that is expected to perform best based on the type of the region (e.g., corresponding to a fuzzy object such as a tree or a solid object such as a building). A region may contain several objects and all of the objects within the region use the same converter. Therefore, to select a good converter, the content within the region should have homogeneous properties, so that a correct converter can be selected. The learning process takes the annotated training data and builds the best region classifier so as to minimize the difference between the output of the classifier and the annotated identifier for the images in the training set. The region classifier 117 is controlled by a set of parameters. For the same input, changing the parameters of the region classifier 117 gives different classification output, i.e. different identifier of the converter. The learning process automatically and continuously changes the parameters of the classifier to some point that the classifier outputs the best classification results for the training data. Then, the parameters are taken as the optimal parameters for future uses. Mathematically, if Means Square Error is used, the cost function to be minimized can be written as follows:

$$Cost ( φ ) = {\sum }_{i} ( {I}_{i} - {f}_{φ} ( {R}_{i} ) ) \qquad ( 2 )$$

where Rᵢ is the region i in the training images, Iᵢ is the identifier of the best converter assigned to the region during annotation process, and f_{φ} ( ) is the classifier whose parameter is represented by φ. The learning process maximizes the above overall cost with respect to the parameter φ.

Different types of classifiers can be chosen for region classification. A popular classifier in the pattern recognition field is Support Vector Machine (SVM). SVM is a non-linear optimization scheme that minimizes the classification error in the training set, but is also able to achieve a small prediction error for the testing set.

The identifier of the converter is then used to select the appropriate converter 118-1 . . . 118-n in the 3D conversion module 118. The selected converter then converts the detected region into a 3D model (step 210). Such converters are known in the art.

As previously discussed, an exemplary converter or conversion mode for solid objects is disclosed in the commonly owned '834 application. This application discloses a system and method for model fitting and registration of objects for 2D-to-3D conversion of images to create stereoscopic images. The system includes a database that stores a variety of 3D models of real-world objects. For a first 2D input image (e.g., the left eye image or reference image), regions to be converted to 3D are identified or outlined by a system operator or automatic detection algorithm. For each region, the system selects a stored 3D model from the database and registers the selected 3D model so the projection of the 3D model matches the image content within the identified region in an optimal way. The matching process can be implemented using geometric approaches or photometric approaches. After a 3D position and pose of the 3D object has been computed for the first 2D image via the registration process, a second image (e.g., the right eye image or complementary image) is created by projecting the 3D scene, which includes the registered 3D objects with deformed texture, onto another imaging plane with a different camera view angle.

Also as previously discussed, an exemplary converter or conversion mode for fuzzy objects is disclosed in the commonly owned '586 application. This application discloses a system and method for recovering three-dimensional (3D) particle systems from two-dimensional (2D) images. The geometry reconstruction system and method recovers 3D particle systems representing the geometry of fuzzy objects from 2D images. The geometry reconstruction system and method identifies fuzzy objects in 2D images, which can, therefore, be generated by a particle system. The identification of the fuzzy objects is either done manually by outlining regions containing the fuzzy objects with image editing tools or by automatic detection algorithms. These fuzzy objects are then further analyzed to develop criteria for matching them to a library of particle systems. The best match is determined by analyzing light properties and surface properties of the image segment both in the frame and temporally, i.e., in a sequential series of images. The system and method simulate and render a particle system selected from the library, and then, compare the rendering result with the fuzzy object in the image. The system and method then determines whether the particle system is a good match or not according to certain matching criteria.

Once all of the objects or detected regions identified in the scene have been converted into 3D space, the complementary image (e.g., the right-eye image) is created by rendering the 3D scene including converted 3D objects and a background plate into another imaging plane, at step 212, different than the imaging plane of the input 2D image, which is determined by a virtual right camera. The rendering may be realized by a rasterization process as in the standard graphics card pipeline, or by more advanced techniques such as ray tracing used in the professional post-production workflow. The position of the new imaging plane is determined by the position and view angle of the virtual right camera. The setting of the position and view angle of the virtual right camera (e.g., the camera simulated in the computer or post-processing device) should result in an imaging plane that is parallel to the imaging plane of the left camera that yields the input image. In one embodiment, this can be achieved by tweaking the position and view angle of the virtual camera and getting feedback by viewing the resulting 3D playback on a display device. The position and view angle of the right camera is adjusted so that the created stereoscopic image can be viewed in the most comfortable way by the viewers.

The projected scene is then stored as a complementary image, e.g., the right-eye image, to the input image, e.g., the left-eye image (step 214). The complementary image will be associated to the input image in any conventional manner so they may be retrieved together at a later point in time. The complementary image may be saved with the input, or reference, image in a digital file 130 creating a stereoscopic film. The digital file 130 may be stored in storage device 124 for later retrieval, e.g., to print a stereoscopic version of the original film.

Although the embodiment which incorporates the teachings of the present disclosure has been shown and described in detail herein, those skilled in the art can readily devise many other varied embodiments that still incorporate these teachings. Having described preferred embodiments for a system and method for region classification of 2D images for 2D-to-3D conversion (which are intended to be illustrative and not limiting), it is noted that modifications and variations can be made by persons skilled in the art in light of the above teachings. It is therefore to be understood that changes may be made in the particular embodiments of the disclosure disclosed which are within the scope and spirit of the disclosure as outlined by the appended claims. Having thus described the disclosure with the details and particularity required by the patent laws, what is claimed and desired protected by Letters Patent is set forth in the appended claims.

1. A three-dimensional conversion method for creating stereoscopic images comprising:
acquiring a two-dimensional image;
identifying a region in the two-dimensional image;
classifying the identified region;
selecting a conversion mode based on the classification of the identified region;
converting the region into a three-dimensional model based on the selected conversion mode; and
creating a complementary image by projecting the three-dimensional model onto an image plane different than an image plane of the acquired two-dimensional image.

2. The method as in claim 1, further comprising:
extracting features from the region;
classifying the extracted features; and
selecting the conversion mode based on the classification of the extracted features.

3. The method as in claim 2, wherein the extracting step further comprises determining a feature vector from the extracted features.

4. The method as in claim 3, wherein the feature vector is employed in the classifying step to classify the identified region.

5. The method as in claim 2, wherein the extracted features are texture and edge direction.

6. The method as in claim 5, further comprising:
determining a feature vector from the texture features and the edge direction features; and
classifying the feature vector to select the conversion mode.

7. The method as in claim 1, wherein the conversion mode is a fuzzy object conversion mode or a solid object conversion mode.

8. The method as in claim 1, wherein the classifying step further comprises:
acquiring a plurality of two-dimensional images;
selecting a region in each of the plurality of two-dimensional images;
annotating the selected region with an optimal conversion mode based on a type of the selected region; and
optimizing the classifying step based on the annotated two-dimensional images.

9. The method as in claim 8, wherein the type of selected region corresponds to a fuzzy object.

10. The method as in claim 8, wherein the type of selected region corresponds to a solid object.

11. A system for three-dimensional conversion of objects from two-dimensional images, the system comprising:
a post-processing device configured for creating a complementary image from a two-dimensional image; the post-processing device including:
a region detector configured for detecting a region in at least one two-dimensional image;
a region classifier configured for classifying a detected region to determine an identifier of at least one converter;
the at least one converter configured for converting a detected region into a three-dimensional model; and
a reconstruction module configured for creating a complementary image by projecting the selected three-dimensional model onto an image plane different than an image plane of the one two-dimensional image.

12. The system as in claim 11, further comprising a feature extractor configured to extract features from the detected region.

13. The system as in claim 12, wherein the feature extractor is further configured to determine a feature vector for inputting into the region classifier.

14. The system as in claim 12, wherein the extracted features are texture and edge direction.

15. The system as in claim 11, wherein the region detector is a segmentation function.

16. The system as in claim 11, wherein the at least one converter is a fuzzy object converter or a solid object converter.

17. The system as in claim 11, further comprising a classifier learner configured to acquire a plurality of two-dimensional images, select at least one region in each of the plurality of two-dimensional images and annotate the selected at least one region with the identifier of an optimal converter based on a type of the selected at least one region, wherein the region classifier is optimized based on the annotated two-dimensional images.

18. The system as in claim 17, wherein the type of selected at least one region corresponds to a fuzzy object.

19. The system as in claim 17, wherein the type of selected at least one region corresponds to a solid object.

20. A program storage device readable by a machine, tangibly embodying a program of instructions executable by the machine to perform method steps for creating stereoscopic images from a two-dimensional image, the method comprising;
acquiring a two-dimensional image;
identifying a region of the two dimensional image;
classifying the identified region;
selecting a conversion mode based on the classification of the identified region;
converting the region into a three-dimensional model based on the selected conversion mode; and
creating a complementary image by projecting the three-dimensional model onto an image plane different than an image plane of the two-dimensional image.
